(19) United States
(12) Patent Application Publication
(10) Pub. No.: US 2026/0219187 A1
(43) Pub. Date: Jul. 30, 2026

(54) NEAR INFRARED FLUORESCENT NANOSENSORS FOR IRON

(71) Applicants: MASSACHUSETTS INSTITUTE OF TECHNOLOGY, Cambridge, MA (US); NATIONAL UNIVERSITY OF SINGAPORE, Singapore (SG)

(72) Inventors: Duc Thinh KHONG, Singapore (SG); Ahsim RIZA, Singapore (SG); Raju CHEERLAVANCHA, Singapore (SG); Mengli CHEN, Singapore (SG); Michael STRANO, Cambridge, MA (US); Gajendra Pratap SINGH, Singapore (SG); Benedetto MARELLI, Cambridge, MA (US)

(21) Appl. No.: 19/148,961

(22) PCT Filed: Jan. 23, 2024
(86) PCT No.: PCT/SG2024/050044

§ 371 Date: Jul. 17, 2025

Related U.S. Application Data
(60) Provisional application No. 63/440,657, filed on Jan. 23, 2023.

(51) Int. Cl. G01N 21/64; B82Y 15/00; C08G 69/32

(52) U.S. Cl. CPC G01N 21/643; C08G 69/32; B82Y 15/00; G01N 2021/6432

(57) ABSTRACT

Disclosed herein is a near infrared (nIR) fluorescent nanosensor for detecting iron species, comprising a complexation of individual single-walled carbon nanotubes (SWNT), wherein the SWNT are nIR fluorescent, and a water-soluble polymer. The nIR fluorescent nanosensors offer a specific and sensitive sensing platform for quantification and speciation of dissolved or bioavailable Fe(II) and Fe(III) in both their free ionic and chelated forms, and have been demonstrated for use in detection of iron via root uptake in planta, as well as in the detection of “free” or non-transferrin bound iron (NTBI) in human serum.

### TECHNICAL FIELD

This disclosure generally relates to systems for the detection of dissolved iron species in living systems, biological systems, or non-biological systems.

### BACKGROUND

This background description is provided for the purpose of generally presenting the context of the disclosure. Contents of this background section are neither expressly nor impliedly admitted as prior art against the present disclosure.

Iron is an essential micronutrient for almost all living organisms as it supports a wide variety of metabolic processes such as oxygen transport, electron transport and DNA synthesis. Despite its abundance in the Earth's crust, most of the iron available is deposited in a water-insoluble iron ore. The iron is hence inaccessible for uptake by living organisms. In response to iron deficiency conditions, various cellular mechanisms have evolved to capture iron from the environment in biologically useful forms. Some graminaceous plants, for example, such as grasses, cereals and rice, secrete iron-chelating compounds called phytosiderophores to capture Fe(III), and transport the resulting iron complex through the root cytoplasmic membrane. Other higher plants have another mechanism where a proton is exuded from the root to the rhizosphere to solubilise and reduce Fe(III) to Fe(II), the latter being more readily absorbed by the transmembrane protein transporter. Plants require iron to synthesise chlorophyll and to maintain the proper function of chloroplast. Iron deficiency in plants, especially in food crops, is common in calcareous soils. This slows down the plant growth, leads to interveinal chlorosis and reduced fitness. Iron levels in plants also need to be tightly regulated as an overload can irreversibly damage plant cells and tissues via generation of free radicals.

In the human body, iron is absorbed via dietary sources and mainly exist in complex forms bound by proteins (haemoprotein) and heme compounds, heme enzymes or non-heme compounds (transferrin and ferritin). Despite the nutrient nature, excessive iron in the body can also be toxic. Disorders of iron metabolism are among the most common diseases in humans and encompass a broad spectrum of diseases with diverse clinical manifestations, ranging from anaemia to iron overload, and possibly to neurodegenerative diseases.

It is therefore important to closely monitor the iron concentration in the body in real-time.

### SUMMARY

Disclosed is a near infrared (nIR) fluorescent nanosensor for detecting iron species, comprising a complexation of:
individual single-walled carbon nanotubes (SWNT), wherein the SWNT are nIR fluorescent; and
a water-soluble polymer.

Also disclosed is a system for detecting iron species in a sample, comprising:
a nIR fluorescent nanosensor as described in any one of claims 1 to 16;
a light source; and
a nIR camera for capturing at least one image, spectrum or partial spectrum, of the sample and/or nIR fluorescent nanosensor after illumination by the light source.

### BRIEF DESCRIPTION OF THE DRAWINGS

Some embodiments of a near infrared (nIR) fluorescent iron nanosensor, in accordance with the present disclosure, will now be described, by way of non-limiting example only, with reference to the accompanying drawings in which:

FIG. 1, comprising FIGS. 1a to 1g, illustrates the performance of a nIR fluorescent nanosensor for detecting iron species, according to an embodiment of the present disclosure. FIG. 1a provides a simplified polymer structure of 34-BPDA-Triazole. FIG. 1b provides the fluorescent response of 34BPDA-Triazole against a library of metal ions (5 ppm 100 mM NaCl solution). FIG. 1c provides the fluorescent response of 34BPDA-Triazole-SWNT to 5 ppm Fe(II) in the presence of other metal ions.

FIG. 2, comprising FIGS. 2a to 2f, illustrates the performance of a nIR fluorescent nanosensor for detecting iron species, according to an embodiment of the present disclosure.

FIG. 3, comprising FIGS. 3a to 3i, illustrates the process and characterisation data of the fabrication of a nIR fluorescent nanosensor for detecting iron species further comprising a sodium alginate hydrogel iron sensor, according to an embodiment of the present disclosure.

FIG. 4, comprising FIGS. 4a to 4c, illustrates the application of the nIR fluorescent nanosensor for use in continuous real-time monitoring of iron levels.

FIG. 5, comprising FIGS. 5a to 5f, illustrates the detection of iron via root uptake in planta.

FIG. 6, comprising FIGS. 6a to 6f, illustrates the detection of “free” or non-transferrin bound iron (NTBI) in human serum.

FIG. 7, comprising FIGS. 7a and 7b, illustrates the design of an iron sensor chip for real-time monitoring of iron content in continuous flow systems.

FIG. 8, comprising FIGS. 8a to 8d, illustrates the real-time monitoring in a hydroponics system using a silk-based iron sensor.

FIG. 9, comprising FIGS. 9a and 9b, illustrates a library of synthetic polyamic acids synthesised for CoPhMoRe constructs for metal screening and a false colour heatmap result of CoPhMoRe's optical response to metal ions.

### DETAILED DESCRIPTION

Embodiments of the present disclosure relate to a near infrared (nIR) fluorescent nanosensor for detecting iron species. In particular, the nIR fluorescent nanosensor detects dissolved iron species in living systems, biological samples and non-biological samples. The iron species comprise one or both Fe(II) and Fe(III) states, also referred to as ferrous and ferric respectively, wherein Fe(II) refers to iron that has lost two electrons and Fe(III) refers to iron that has lost three electrons.

In some embodiments of the present disclosure, the claimed nIR fluorescent nanosensors were developed based on Corona Phase Molecular Recognition (CoPhMoRe). CoPhMoRe uses a heteropolymer adsorbed onto and templated by a nanoparticle surface to recognise a specific target analyte. The sensor can be further chemically modified for detection of other analytes. These analytes may include one or more of boron (B), zinc (Zn), manganese (Mn), iron (Fe), copper (Cu), molybdenum (Mo) and chlorine (CI).

In some embodiments, the claimed nIR fluorescent nanosensors comprise a complexation of nIR fluorescent single-walled carbon nanotubes (SWNT) and a water-soluble synthetic polymer. For example, the synthetic polymer may be non-covalently adsorbed on the SWNT surface, forming a unique binding pocket which selectively interacts with iron ions. The nIR fluorescence of the SWNT is modulated in a concentration-dependent manner by dissolved iron species in the vicinity of the nanosensors.

### nIR Fluorescent Nanosensors for Fe(II) Detection

In some embodiments, the nIR fluorescent nanosensor is sensitive and specific to Fe(II) species. The nanosensor may be constructed from a non-covalent conjugation of a synthetic polymer on SWNT surface. The synthetic polymer may be selected from a series of polymers which are amphiphilic, such as a polyamic acid sodium salt, having a hydrophobic backbone, providing ready adsorption on SWNT surfaces due to strong pi-pi interactions, pendant carboxylate anions for water solubility, and pyridyl groups on the backbone for potential chelation with Fe(II). The polyamic acid may arise from the condensation of aromatic anhydride and diamine monomers, with N-heterocyclic rings (like triazole or pyridine) playing a crucial role in selective Fe(II) recognition. The synthetic polymer may be 34BDPA-Triazole, a polymer derived from polyamic acid.

In some embodiments, 34BPDA-Triazole was synthesised from polycondensation of a dianhydride monomer (3,4′-biphthalic anhydride, abbreviated as 34BPDA) and a diamine monomer (3,5-diamino-1,2,4-triazole, abbreviated as Triazole) with 1:1 molar ratio using dry N-methyl-2-pyrrolidone (10 wt % basis) as the solvent at room temperature under inert atmosphere. After 24 hours, the resulting solution was diluted with excess NaOH 0.1M aqueous, followed by dialysis (MWCO 12-14 kDa) against DI water for 48 hours. After dialysis, the content in the tube is freeze-dried to give white fluffy powder as the desired polymer.

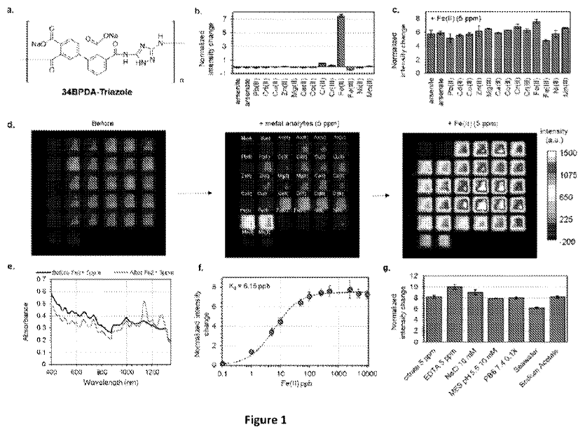

FIG. 1 illustrates the performance of a first iron nanosensor 34BPDA-Triazole SWNT in solution state, according to the first embodiment as described. Where there is an error bar, the error bar indicates the standard deviation of independent triplicate measurements. FIG. 1a provides a simplified structure of 34BPDA-Triazole. The amide bonds on the polymer backbone were shown in trans-trans configuration relative to the dianhydride monomer. Due to the random nature of ring-opening, other configurational isomerism exist in another one or more embodiments (i.e., cis-cis and cis-trans).

To fabricate the first iron nanosensor based on a 34BPDA-Triazole polymer, a suspension of purified HiPCO (or CoMoCat chirality (6,5)) SWNT with a weight concentration of 1 mg SWNT/mL in aqueous 34BPDA-Triazole polymer solution (5 mg polymer/mL DI water) was tip-sonicated for one hour. The resulting suspension was centrifuged (17000 rcf, 90 minutes) and the supernatant was collected and centrifuged one more time (17000 rcf, 90 minutes). The concentration of 34BPDA-Triazole-SWNT (mg/L) in the resulting supernatant was estimated as the ratio of its absorbance value at 632 nm to its corresponding extinction coefficient value. This value was estimated to be 0.63.

FIG. 1b provides a summary of the fluorescent responses of 34BPDA-Triazole-SWNT against a library of metal ions (5 ppm in 100 mM NaCl solution). The fluorescent response was calculated as normalized intensity change (I-Io)/Io where Io and I are the average nIR fluorescent intensity of 34BPDA-Triazole-SWNT (2 mg/L in 100 mM NaCl solution) before and after the addition of metal ions. A negative normalised intensity change indicates a quenching response, while a positive value indicates a turn-on response. The data presented in FIG. 1b shows that the fluorescent intensity of the first iron nanosensor increased by at least seven times in the presence of 5 ppm Fe(II) (from ferrous sulfate), while it remains relatively inert to other metal ions. Lesser turn-on responses were observed in the cases of Cr(II) and Cr(III), and moderate quenching response was also observed for Fe(III).

FIG. 1c provides a summary of the fluorescent responses of the first iron nanosensor to 5 ppm Fe(II) in the presence of other metal ions (5 ppm 100 mM NaCl solution)-shown along the x-axis. The data validates the specificity and selectivity of the first iron nanosensor by showing the preferred and dominant turn-on response of the sensor towards 5 ppm Fe(II) in the presence of other metal ions (5 ppm).

The data presented in FIGS. 1b and 1c were obtained using a high-throughput screening strategy developed specifically for in-vitro sensor screening and characterization against different metal ions, the stages of which are reflected in FIG. 1d. Using a 384-well plate (black polystyrene, black bottom), the nanosensor solution as prepared according to the fabrication process outlined for the first embodiment of the present disclosure was aliquoted to each well (110 μL, 2 mg SWNT/L), accounting for the number of analytes to be tested (including control or blank) and number of repeats (duplicate or triplicate). The resulting 384-well plate was excited with 785 nm laser diode using a divergent beam to cover all the wells containing the nanosensor solution. The nIR fluorescent image of these wells were captured using a lab-built stand-off nIR camera system with 2D InGaAs detector. Other imaging devices may be used to capture an image of the sample, or a spectrum or partial spectrum (e.g. full or partial light spectrum) of the sample.

FIG. 1d presents a series of false colour nIR images of the solutions of the first iron nanosensor in each well (as a square for each sample) before (left-110 μL of 2 mg SWNT basis/mL in 100 mM NaCl aqueous solution), after the addition of respective metal ions (center-1.1 μL of 50 ppm stock solution), and after further addition of Fe(II) (right-5 ppm). The optical response was calculated based on the average intensity change of each well before (Io) and after the addition of the respective metal ions (I). The two wells at the top right were used as the blank (control samples).

The interaction between the first iron nanosensor and Fe(II) was further validated by the UV-vis-NIR spectrometer. FIG. 1e presents the UV-vis-NIR absorption spectrum, wherein the data illustrates a significant change in the 900-1400 nm region before and after the addition of Fe(II).

FIG. 1f provides a calibration curve of the 34BPDA-Triazole-SWNT (the first iron nanosensor) in 100 mM NaCl aqueous solution against different Fe(II) concentrations. FIG. 1f shows a dissociation constant estimated at Kd=6.15 ppb using the Langmuir isotherm adsorption model.

FIG. 1g further provides the fluorescence response of the first iron nanosensor to Fe(II) (5 ppm) in different aqueous environments. The data in FIG. 1g provides evidence for the robustness and versatility of this iron nanosensor, wherein a similar degree of turn-on response to Fe(II) is observed in various different aqueous environments.

### nIR Fluorescent Nanosensors for Differentiating Fe(II) and Fe(III)

In some embodiments, a synthetic polymer poly(phenylene ethynylene) (PPE) was used as the water soluble polymer (“second” iron nanosensor). The second nIR fluorescent iron nanosensor provides a strong turn-on response to Fe(II) while giving quenching response to Fe(III) in solution state. Thus, the second iron nanosensor is an orthogonal fluorescent iron sensor capable of differentiating Fe(II) and Fe(III).

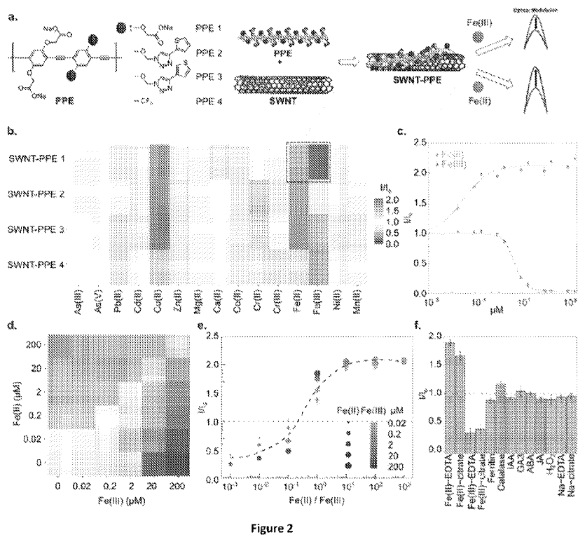

FIG. 2 illustrates the performance of a second iron nanosensor PPE-SWNT in solution state, according to the second embodiment as described. FIG. 2a provides a chemical structure of four SWNT-PPE 1-4 complexes synthesised and screen for iron sensing. PPE 1, a linear conjugated polymer with negatively charged carboxylate side groups, was found to have shown amplified fluorescence sensing capabilities with protease and lead Pb(II). The synthesis of PPE 1-4 were carried out by Sonagashira's coupling reaction. In PPE 2-3, triazole-thiophene subgroups were introduced to assess any improvements in sensing activity resulting from thio-metal interactions. Furthermore, the electron density on the polymer backbone in PPE 4 was modulated to investigate its potential influence on sensing activity. Screening of PPE 1 and PPE 2 revealed non-selective aggregation quenching against most divalent metals).

In some embodiments, the SWNT-PPE conjugates were synthesised according to a tip-sonication method with HiPCOR (or CoMoCat® chirality (6,5)) as the nanotube base. UV-Vis-nIR spectroscopy confirmed well-dispersed suspensions of SWNT-PPE 1-4 complexes with a suspension yield of 200-300 mg/L.

Screening of SWNT-PPE 1-4 against a library of metal ions demonstrated a significant improvement in optical modulation selectivity compared to their corresponding free polymers. In particular, the screening was carried out using a 785 nm laser diode system as the excitation source and their nIR fluorescence was collected by a stand-off liquid nitrogen-cooled 2D InGaAs detector. Optical modulation was calculated using the formula I/Io where Io and I are the fluorescent intensity before and after the addition of the respective metal ions.

FIG. 2b provides a false-colour heat map generated in this screening experiment. FIG. 2b shows that these conjugates are relatively inert to all of the test ions, except for the quenching responses to Cu(II) and Fe(III) and turn-on response to Fe(II). The triazole-thiophene group on the PPE side chain dampened the quenching response to Fe(III) in SWNT-PPE 2 but enhanced the response to Fe(II) and Cu(II) in SWNT-PPE 3. Presence of electron-withdrawing groups —CF3 reduced the electron density on the polymer backbone of SWNT-PPE 4, making it less responsive to electron-poor analytes and resulting in decreased fluorescence response. Overall, SWNT-PPE 1 exhibited balanced responses to Fe(II) (turn on, I/Io~1.8) and Fe(III) (quenching, I/Io~0.1), with lesser response to Cu(II) (quenching, I/Io~0.3). Preliminary cross-reactivity tests of SWNT-PPE 1 with equimolar Fe(II):Cu(II) or Fe(II):Fe(III) mixtures indicated a more specific response to Fe(II), suggesting its potential as an orthogonal sensor for detecting and differentiating iron species. Since the relative content of Cu(II) in plant systems is approximately ten times less than the iron content, it is unlikely that the iron sensor activity will be significantly interfered with by endogenous Cu(II).

FIG. 2c shows the in vitro calibration curves of SWNT-PPE 1 for iron species, with concentrations ranging from 10-3 μM to 103 μM. FIG. 2c suggests different response profiles for Fe(II) and Fe(III), with the error bar indicating the standard deviation of independent triplicate measurements. The dynamic response range for Fe(II) was 10⁻³ to 1 μM, with minimal overlap with the range for Fe(III), which was 1 to 10 UM. Assuming that the degree of optical modulation is linearly proportional to the relative coverage of binding sites on the nanotube surface, the calibration data were fitted with the Hill isotherm model, where B is the proportionality factor, Kd is the dissociation constant, C is the iron concentration, and n is the cooperativity Hill coefficient. FIG. 2c presents a much smaller Kd value of PPE-SWNT to Fe(II) than that in Fe(III). The fitted Kd values were estimated as 0.032±0.01 UM for Fe(II) and 4.71±0.29 UM for Fe(III), indicating a higher affinity of SWNT-PPE 1 for Fe(II) compared to Fe(III). The Hill coefficient, which reflects the steepness and cooperativity of analyte binding, was found to be <1 for Fe(II) (n=0.78) and >1 for Fe(III) (n=1.86), suggesting distinct binding mechanisms of SWNT-PPE 1 for Fe(II) and Fe(III).

To assess the cross-reactivity performance of SWNT-PPE 1, the optical modulation I/Io in the presence of a mixture of Fe(II) and Fe(III) at varying concentrations was measured. FIG. 2d provides a heat map revealing that the optical modulation depends on the concentrations of both Fe(II) and Fe(III). The upper diagonal of the map showed a turn-on response (light green to green), while the lower diagonal showed quenching, especially when Fe(III) concentration exceeded 20 UM (light red to red). Non-specific modulation was observed (yellow) when iron levels were low and the Fe(II):Fe(III) ratio was close to 1.

FIG. 2e shows a scatterplot based on the data from FIG. 2d demonstrated a clear relationship between the Fe(II)/Fe(III) ratio and optical modulation, exhibiting a sigmoidal-like trend curve indicating a threshold where the sensor switched its detection mode. Below a ratio of 0.1, the sensor entered the quenching domain, with its response proportional to Fe(III) concentration. Conversely, a ratio of >1 resulted in the sensor entering the turn-on domain, with its response proportional to Fe(II) levels. These findings indicate that SWNT-PPE 1 exhibits orthogonality and can detect and differentiate predominant iron species with minimal interference.

In plants, where iron species are commonly found in complex forms with small molecule ligands or proteins, SWNT-PPE 1 was also observed to detect free ionic iron species and small molecule chelated iron complexes, including Fe(II) and Fe(III) chelated with EDTA or citrate ligands, albeit to a slightly lesser extent than free species.

FIG. 2f provides a real-time fluorescent response of PPE-SWNT to a mixture containing Fe(II) and Cu(II) in 1:1 weight concentration ratio showing a turn-on signal in response to only Fe(II). Additionally, the sensor did not respond to protein-bound iron species such ferritin and catalase, common plant hormones (IAA, ABA, GA, and JA), or reactive oxygen species (ROS) signalling molecules like H2O2.

Consequently, SWNT-PPE 1 is unlikely to be susceptible to interference from these non-target molecules. As the first sensor capable of real-time detection and differentiation of iron species, SWNT-PPE 1 has the potential to provide novel insights into iron uptake, transport, and homeostasis in biological systems.

nIR Fluorescent Nanosensors with Hydrogel Encapsulation

In some embodiments, the claimed nIR fluorescent nanosensor further comprises a compatible hydrogel matrix encapsulating the nanoparticles. In the presence of a compatible hydrogel matrix, these nIR fluorescent nanosensors can be immobilised in the hydrogel matrix in a manner that allows dissolved iron to be diffused into the matrix and to interact with the sensors in a reversible manner.

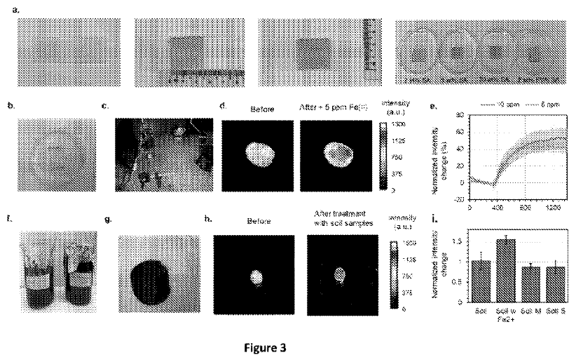

FIG. 3 illustrates the fabrication of a hydrogel-based iron nanosensor and its application to measure ferrous iron Fe(II) in soil samples. A hydrogel-based system provides an excellent interface for iron sensing in complex samples (Sun et al., 2021). The nanosensor immobilised in a hydrogel matrix improves portability and prevents contamination of nanoparticles to the surrounding environment. The hydrogel matrix has excellent molecular permeability which can be modified for selective diffusion of target analytes.

In some embodiments, the hydrogel used may be sodium alginate (SA). Detection of ferrous iron Fe(II) is carried out using sodium alginate-based hydrogel immobilised with 34BPDA-Triazole-SWNT iron nanosensors. By mixing an aqueous sodium alginate stock solution and 34BPDA-Triazole-SWNT solution, a final blend containing 10 mg SWNT/L and 2 wt % sodium alginate is achieved. The viscous blend was drop casted on a customised glass mould to pre-form a hydrogel film with a thickness that can be customised to 1 mm or 2 mm. With the lid covered and two sides available for diffusion of the cross-linking agent, the mould is submerged in 0.1 N CaCl₂) aqueous solution for 24 hours. During this process, calcium ions gradually diffuse and cross-linked with alginate polymers, forming a 3D hydrogel matrix.

FIG. 3a shows a series of photographs of lab-made glass mold for fabrication of a 1-2-mm thick hydrogel film, the dimensions of fabricated hydrogel with 34BPDA-Triazole-SWNT, and the compatibility of 34BPDA-Triazole-SWNT in different types of hydrogel.

FIG. 3b shows a round hydrogel iron nanosensor (diameter of 2-3 mm) wrapped by regenerated cellulose dialysis membrane (MWCO 12-14 kDa) and submerged in 100 mM NaCl solution to maintain hydrogel structural integrity. The dialysis membrane protects the hydrogel from damage while facilitating the diffusion of water-soluble iron to the gel system. The in-vitro experiments demonstrate that water-soluble ferrous ions may pass through the membrane, diffuse into the gel, interact with the immobilised 34BPDA-Triazole-SWNT iron nanosensor, and trigger a nIR fluorescent response.

FIG. 3c shows a photograph of a setup used, wherein a laser source is used to continuously excite the hydrogel in contact with the sample. The hydrogel nIR fluorescence is captured by the stand-off camera assisted by a 90-degree mirror, with a 2D InGaAs detector.

FIG. 3d shows the representative nIR images of the hydrogel iron nanosensor before and 15 minutes after the addition of FeSO4 into the petri dish. An increase in fluorescent intensity was observed in these two photos after the addition of FeO4, with a final concentration of 5 ppm Fe(II). The turn-on response from the gel confirmed that water soluble Fe(II) outside the membrane can diffuse through and interact with the immobilised iron nanosensor.

FIG. 3e presents the real-time normalised fluorescence change of the hydrogel iron nanosensor in response to varying Fe(II) concentrations in the solution. A gradual increase in fluorescent intensity was observed, and likely to be due to the diffusion limit of Fe(II) into the gel.

The detection of ferrous iron into soil was also demonstrated in soil collection from commercial sources, used for vegetation as well as soils collected in mangrove areas around coastal Singapore. FIG. 3f shows a photograph of soil samples used in iron measurement by the hydrogel iron sensor. Ultrapure water was added to the soil to facilitate the leeching and dissolution of water-soluble iron to the aqueous phase. On the right of FIG. 3f, the photograph shows soil that was spiked with a 5 ppm solution of Fe(II).

FIG. 3g shows a wet soil sample was placed directly on top of the iron nanosensor prototype, to facilitate detection of dissolved iron in the soil. The photograph was captured after the removal of the soil, and a subsequent rinsing step of the gel-membrane system.

FIG. 3h shows the false-color nIR image of the tested hydrogel before and after the application of soil. The increase in fluorescent intensity was clearly observed after the soil was applied, indicating the detection of ferrous ions in these experiments. Conversion of fluorescent intensity change to true iron concentration can be obtained by establishing the calibration and correlation curves between iron nanosensor intensity change and true iron level determined by spectroscopic methods (i.e., ICP-MS or FAAS).

DI water was added to the soil to form a sludge to facilitate the dissolution of ferrous iron. An increase in the fluorescent intensity was observed after the soil was applied, indicating that the detection of ferrous ions in these experiments was present. FIG. 3i summarises the final optical response value in different types of soil. This suggests robustness of hydrogel iron nanosensors in different environments. The fluorescent intensity changes may be converted to a true iron concentration by establishing the calibration and correlation curves between iron nanosensor intensity changes. The true iron levels can be determined by spectroscopic methods.

### nIR Fluorescent Iron Nanosensors for Use in Irrigation or Hydroponics

In some embodiments, a hydrogel iron nanosensor may also be used for continuous monitoring of iron levels in aqueous media for use in irrigation or hydroponics systems. This ability for continuous monitoring of micronutrients is important for quality control of a feeding system to ensure that the correct nutrient profile is provided for optimal crop production.

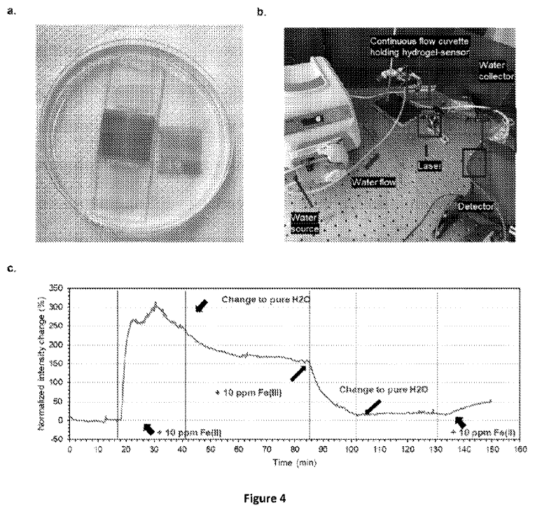

Here, an alginate PPE-SWNT hydrogel was prepared using the procedure described. FIG. 4 illustrates the application of PPE-SWNT hydrogel for continuous real-time monitoring of iron level in a continuous process.

Continuous monitoring of micronutrient is important for quality control of feeding system to ensure that correct nutrient profile is provided for optimal crop production.

FIG. 4a illustrates the alginate PPE-SWNT hydrogel prepared using same procedure described in the previous section. The feasibility of PPE-SWNT hydrogel in testing iron level in continuously flowing water system, imitating the water recycling process used in irrigation or hydroponics system.

FIG. 4b shows a photograph of laboratory setup for this experiment. The setup consisted of a sensing system made from a flow through quart cuvette with a round piece of hydrogel iron nanosensor was immobilised. The cuvette inlet port was connected to a water source via a silicone tubing and the outlet port was connected to a receiver tank via another silicone tubing. A diaphragm pump was used to drive the water sample from the source, passing through the cuvette to the receiving end from the outlet port. The cuvette was excited with a 785 nm laser diode and its fluorescent images were captured using stand-off camera with 2D InGaAs detector. Different water sources (i.e., pure water, Fe(II) 10 ppm, or Fe(III) 10 ppm) containing different amount of irons were switched to check the real-time response of PPE-SWNT. PPE-SWNT is developed as orthogonal iron sensor in which fluorescent intensity would turn on if Fe(II) level is dominant and quench if Fe(III) level is dominant.

FIG. 4c summarises the normalized intensity change in response to changing iron level in the water system (as indicated by the black arrows). It can be seen that the sensor signal reacted accordingly as the fluorescent intensity increased when Fe(II) was added, or fluorescent intensity starts to go back to the background level when Fe(II) was removed from the stream and quenched further when Fe(III) was added. This result demonstrates the feasibility of using hydrogel iron nanosensor for monitoring iron level in continuous process. The limit of detection (i.e. sensitivity) and response time of the sensor-hydrogel composite can be further improved by optimizing the chemical composition and physical properties of the hydrogel matrix. This optimization is to facilitate efficient interaction between the sensor and the analyte through enhanced mass transport and binding kinetics.

### nIR Fluorescent Nanosensors for Detection of Iron Via Root Uptake in Planta

In some embodiments, the nIR fluorescent nanosensor is used to detect iron via root uptake in planta. In one example, the PPE-SWNT iron nanosensor is used for real-time monitoring of iron status in the Nicotiana benthamiana (tobacco) living plant model. The PPE-SWNT iron nanosensor may be functionalised into the leaf tissue to monitor for iron accumulation and homeostasis during exogeneous iron uptake from the soil medium. PPE-SWNT (10 mg SWNT/L in 10 mM MES buffer pH 5.5) was infiltrated into the abaxial surface of tobacco leaf (3-4 weeks-old).

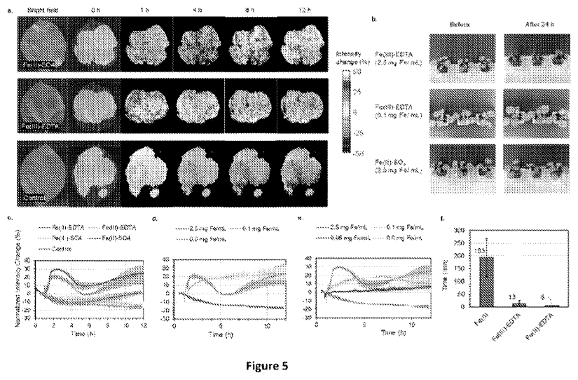

FIG. 5a provides a series of normalised false-colour nIR images, calculated as normalised intensity changes, obtained from plant samples where the soils are treated with different types of iron sources commonly used in iron fertilisers, at different points in time before and after the soil was enriched with iron. These iron fertilisers include ferrous sulphate and a blank. As described, PPE-SWNT is an iron orthogonal sensor which provides a turn-on response when Fe(II) is dominant and provides a quenching response when Fe(III) is dominant. The evolution of the pixels in these photographs provide an idea of the spatial and temporal evolution of which of the two iron species were dominantly present in the leaf.

The PPE-SWNT response can be observed when ferrous sulfate or ferric-EDTA was added to the soil can be clearly distinguished. In the case of ferrous sulfate (2.5 mg Fe/mL solution), quenching response can be observed after 1 hour at the veinous area, indicating the preferable transport of Fe(III) from the xylem to vein. This can be seen in FIG. 5a at the 1 h and 4 h marks. The accumulation of Fe(II) in the leaf lamina (non-veinous area) as shown by gradual turn-on response of PPE-SWNT signal after 4 h is also observed, as shown in FIG. 5a, at the 4 h, 8 h and 12 h marks.

In the case of chelated iron (2.5 mg Fe/mL solution), PPE-SWNT in the leaf tissue can detect the uptake of chelated iron within 5-15 minutes, indicating a much faster absorption mechanism for chelated iron comparing to free ferrous ions. It can be seen from the nIR images in the middle row of FIG. 5a that PPE-SWNT gave strong turn on response at the veinous area (instead of quenching response in the case of free ferrous iron), following by quenching response in the leaf lamina after 4 hours. The opposite observations perceived by sensor between free ferrous iron and chelated iron highlighted the distinct iron uptake strategies developed by plant for different iron species.

FIG. 5b illustrates the photographs of the plants before and after fertilisation with different iron species and concentration. Damage of iron toxicity and overloading to plants when too much iron is absorbed from the root can be observed. The fast and overloaded uptake of chelated iron (2.5 mg Fe/mL) resulted in plant death after 24 hours due to iron toxicity but remained healthy when a much smaller concentration of ferric-edta (0.1 mg Fe/mL) was used. When the same amount of iron but in ferrous sulfate (2.5 mg Fe/mL) was used, the plant remained healthy due to a more controlled and slower iron uptake. Therefore, real-time monitoring of iron in planta using PPE-SWNT can generate unique sensor signal profiles corresponding to specific type and concentration of iron sources used in the soil.

FIG. 5c illustrated the average sensor response to chelated Fe(II), chelated Fe(III), free Fe(III) and free Fe(II) at 2.5 mg Fe/mL concentration. In general, chelated Fe(II) and chelated Fe(III) were absorbed quickly into the root and transported to the leaf, and were detected by PPE-SWNT within 5-15 minutes after iron enrichment, as indicated by a clear turn on response.

FIGS. 5d and 5e provide the real-time average fluorescent intensity change of PPE-SWNT in the Nicotiana benthamiana leaf showing the change in signal responses as different concentrations of iron species were being used for fertilisation, for chelated Fe(II)-EDTA and chelated Fe(III)-EDTA respectively.

In general, chelated Fe(II) and chelated Fe(III) were absorbed quickly into the root and transported to the leaf to be detected by PPE-SWNT within 5-15 minutes after iron enrichment, as indicated by a clear turn on response in FIG. 5d. Calculation of lag time from the time of iron enrichment in soil to the time where the PPE-SWNT nanosensor gives a turn-on signal showing that the absorption and transport of Fe(II) from the soil to leaf tissue is faster than that of Fe(III). This observation has also been illustrated in FIG. 5f. The faster absorption rate of chelated Fe(II) comparing to chelated Fe(III) is supported from iron uptake strategy theory in non-grass plants where chelated Fe(III) has to be reduced by ferric chelate reductase (FRO2) to chelated Fe(II) in order to be transported through root membrane using divalent cation transporter (IRT1). The extra reduction step can be accounted for the difference in lag time between chelated Fe(II) fertilisation and chelated Fe(III) fertilization.

On the other hand, when free ferric iron (from iron (III) sulfate) is added, the sensor signal is similar to that of the control signal, indicating that there might be little to no iron absorption from free ferric sources. This observation is supported as it is reported that there is no known mechanism for non-grass type plant to uptake free ferric iron. The absorption of free ferrous ions was slower compared to those of chelated irons as it would take at least three hours to observe the turning on signal. The slower uptake of free ferrous iron might be because IRT1 favours the transport of chelated Fe(II). At extremely high chelated iron loading (2.5 mg Fe/mL) which resulted in plant death, a unique wavy-like signal indicates the possibility of iron toxicity. At lower iron level loading (0.1 mg and 0.05 mg Fe/mL) which did not result in imminent iron toxicity, a more sustainable turn-on response was observed in both cases. The correlation of exogeneous iron concentration (whether in deficiency or excess) and sensor response curves versus crop health can be established as s database for real time monitoring and prediction of iron status in planta to ensure optimal amount of iron is maintained for plant health.

At extremely high chelated iron loading (2.5 mg Fe/mL) which resulted in plant death, a unique wavy-like signal indicates the possibility of iron toxicity. At lower iron level loading (0.1 mg and 0.05 mg Fe/mL) which did not result in imminent iron toxicity, a more sustainable turn-on responses were observed in both cases. These experiments indicate the potential application of iron nanosensor in planta for real-time monitoring of iron level in plant with high dynamic and sensitivity. A correlation of exogenous iron concentration (deficiency or excess) and sensor response curves versus crop health can be establish as a database for real time monitoring and prediction of iron status in planta to ensure optimal amount of iron is maintained for plant health.

FIG. 5f shows that the lag time from the time point of iron enrichment in soil to the time point where PPE-SWNT giving turn-on signal showed that absorption and transport of Fe(II) from the soil to leaf tissue is faster than that of Fe(III). The faster absorption rate of chelated Fe(II) comparing to chelated Fe(III) is supported from iron uptake strategy theory in non-grass plants where chelated Fe(III) has to be reduced by ferric chelate reductase (FRO2) to chelated Fe(II) in order to be transported through root membrane using a divalent cation transporter (IRT1). The extra reduction step can be accounted for the difference in lag time between chelated Fe(II) fertilisation and chelated Fe(III) fertilisation.

When free ferric iron (from iron (III) sulphate) is added, the sensor signal is similar to that of a control signal, indicating that there might be little to no iron absorption from free ferric source. This observation is supported as it is reported that there is no known mechanism for non-grass type plant to uptake free ferric iron (Kim & Guerinot, 2007). The absorption of free ferrous ions was slower compared to those of chelated irons as it would take at least three hours to observe the turning on signal. This may be supported by the data in FIGS. 5c and 5f. The slower uptake of free ferrous iron might be because IRT1 favours the transport of chelated Fe(II).

The nIR figures in FIG. 5a showed opposite sensing response to free ferrous iron and chelated iron, indicating that plants might have different uptake or transport strategy for free Fe(II). The sensor signal profiles can be used as an indicator for iron accumulation and an alerting mechanism for iron toxicity and deficiency.

### nIR Fluorescent Iron Nanosensors for Detection of NTBI in Human Serum

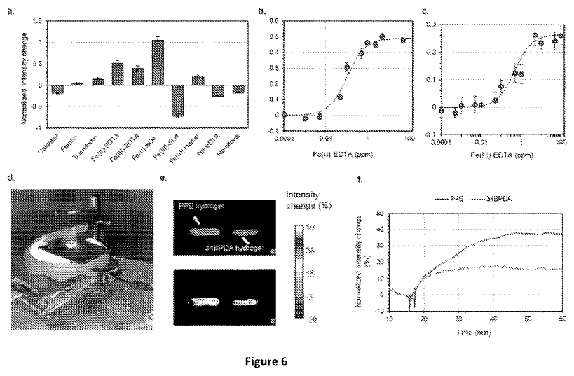

In some embodiments, the nIR fluorescent iron nanosensor is used in the detection of free or non-transferrin bound iron (NTBI) in human serum. FIG. 6 summarises the demonstration of potential application of the hydrogel iron nanosensor for detection of NTBI in human serum. The direct interaction between “labile iron” and the iron nanosensor allows for a rapid detection and quantification of iron levels with high specificity, sensitivity and minimal downtime. Immobilisation of iron sensor inside the hydrogel allows compartmentalisation between the iron sensor and the biological environment with sufficient porosity for the diffusion of NTBI into the gel matrix. This prevents the risk of contamination and potential interferents.

FIG. 6a illustrates the fluorescent response, calculated as normalised intensity change, of the PPE-SWNT sodium alginate hydrogel, fabricated according to the procedure described in an earlier embodiment, against a library of relevant iron-containing proteins.

In one example, fluorescent modulation of the iron nanosensor PPE-SWNT in alginate, calculated as normalised fluorescent change, was screened against a common list of iron-containing proteins (e.g. catalase, ferritin, transferrin), low molecular weight iron complexes (e.g. Fe(II)-EDTA, Fe(III)-EDTA, Fe(III)-hemin), free irons (e.g. Fe(II) and Fe(III)), and ligands (e.g. EDTA and citrate). At 1 ppm level of each tested analyte, PPE-SWNT-alginate responded significantly to Fe(II)-EDTA, Fe(III)-EDTA, and ferrous sulfate Fe(II)—SO4 with turn-on responses, and quenched in the presence of ferric sulfate Fe(III)—SO4. On the other hand, the sensor is not responsive to iron-containing proteins and other common ligands. This shows that the sensor is specific to low-molecular weight iron complexes. Due to the excess presence of anionic ligands in biological environments, irons essentially exist in chelated forms bound by proteins or low-molecular weight ligands. The responses of the iron nanosensors have hence been calibrated to the chelated forms of iron to obtain the curves in FIGS. 6b and 6c.

In some embodiments, the nIR fluorescent iron nanosensor of 34BPDA-Triazole-SWNT-alginate was used in the detection of labile iron NTBI. FIG. 6d shows a setup used to demonstrate the feasibility of detection of free iron in human serum using the hydrogel iron sensor. The sensor gel is submerged and stabilised with DI water contained in a quartz cuvette. nIR fluorescence of the gel is generated by a 785 nm laser diode and monitored by stand-off NIR camera set up with a 2D InGaAs detector.

The nIR images of the gel and its average normalised fluorescent intensity change are continuously captured before and after the injection of human serum sample to the cuvette. A human serum sample is added such that the 10× dilution of human serum is achieved in the final volume. The false colour nIR images (FIG. 6, image (e)) clearly indicate the turn-on response in the gel after the serum was added. This provides an indication that detection of NTBI in human serum had occurred.

In some embodiments, the nIR fluorescent iron nanosensor of PPE-SWNT-alginate was also used in the detection of labile iron NTBI.

In a comparison of both cases, PPE-SWNT-alginate provides a larger response in comparison to 34BPDA-Triazole-alginate. The normalised intensity changes of both nanosensors are presented in FIG. 6f, which show the real-time detection by the gel, in vitro. Equilibrium in the optical response is limited by the diffusion rate of NTBI into the matrix and is reached in approximately 30 minutes.

### Design of Iron Sensor Chip for Real-Time Monitoring of Iron Content in Continuous Flow Systems

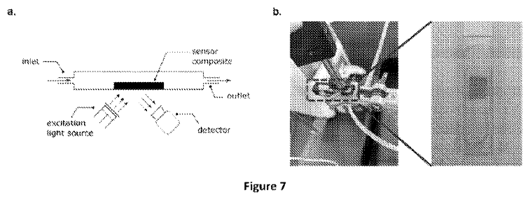

FIG. 7 illustrates a sensing module designed and utilised for the immobilisation of 34BPDA-Triazole-SWNT and/or PPE-SWNT in a matrix as the sensing material, for the purpose of real-time monitoring of iron content in a continuous flow system. The matrix is integrated with a flow-through chamber, enabling direct sample contact with the sensor layer. At a precise distance, the module interfaces with both an excitation source and a fluorometer. The excitation source emits light which interacts with the iron nanosensor and causes it to fluoresce. The fluorometer then captures and analyses this fluorescence, providing a quantitative measure of iron concentration in the sample. This is illustrated in FIG. 7a.

FIG. 7b illustrates a lab set-up of the experimental design, where a silk-based thin film is functionalised with 34BPDA-Triazole-SWNT for Fe(II) detection, and attached to a flow-through cuvette connected to the sample source. The thin film sensor is excited with an optical excitation probe and its fluorescence is collected with the back-scattering collection probe.

### Real-Time Monitoring in a Hydroponics System Using Silk-Based Iron Sensor

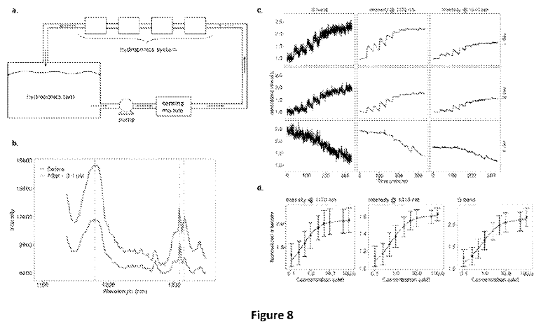

FIG. 8 illustrates the iron based nanosensor in real-time iron monitoring in a hydroponics system. Deficiency in iron is a widespread problem in hydroponics crops, causing sub-optimal growth and, in severe cases, iron chlorosis characterized by leaf yellowing. This directly impacts crop yield and quality, ultimately affecting human health, particularly in populations reliant on plant-based diets.

FIG. 8a illustrates a schematic set-up of a hydroponics system with an integrated iron sensing module. The module consists of a silk-based sensor film in a flow cuvette interfacing with an optical excitation probe and back-scattering collection.

The sensing module according to a previous embodiment was seamless integrated into an existing setup, allowing the flowing nutrient solution to continuously interact with the iron nanosensor embedded within the silk biomaterial matrix. Using the optical excitation probe (excitation wavelength of 1064 nm) with back-scattering collection, immobilization of Fe(II) sensor (34BPDA-Triazole-SWNT) into the silk fibroin film was shown to retain its sensing activity to Fe(II) in the hydroponics media.

FIG. 8b shows the typical nIR fluorescent spectrum of the silk-based sensor film in response to the addition of Fe(II). The turn-on response of the silk-based sensor to Fe(II) can be quantified by tracking the total intensity change or at specific emission wavelengths.

FIGS. 8c and 8d showcase the sensor's responsiveness to changes in iron levels in the hydroponics media, demonstrating its ability to track dynamic changes in the nutrient solution. The calibration profiles of the silk-based sensor silk film are slightly different in terms of the dissociation constant values Kd.

The silk-based sensor film is water-insoluble and mechanically stable in the hydroponics media, non-detectable nanotube leaching, and remained functional for at least one month. The sensing module can be further coupled with a feedback control system to form an automated and integrated micronutrient management system to empower growers to maintain iron concentrations within optimal range for specific crops at different growth stages, maximizing plant growth and yield while minimizing fertilizer waste and potential environmental impact.

### Selection of CoPhMoRe Candidates

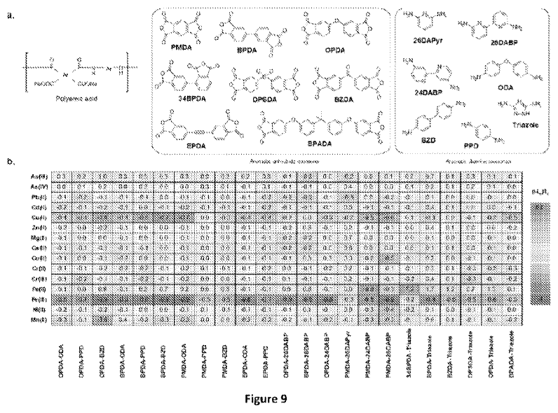

FIG. 9a shows a library of synthetic polyamic acids synthesised for CoPhMoRe constructs for metal screening. FIG. 9b shows a false-colour heat map results of CoPhMoRe's optical responses to metal irons. The screening of candidates against various metal ions provides for the development of Fe(II) and Fe(III) specific iron nanosensors.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise” and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited elements(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

1. A near infrared (nIR) fluorescent nanosensor for detecting iron species, comprising a complexation of:
individual single-walled carbon nanotubes (SWNT), wherein the SWNT are nIR fluorescent; and
a water-soluble polymer.

2. The nIR fluorescent nanosensor as described claim 1, wherein the water-soluble polymer is a synthetic polymer.

3. The nIR fluorescent nanosensor as described claim 2, wherein the water-soluble polymer is amphiphilic.

4. The nIR fluorescent nanosensor as described in claim 3, wherein the water-soluble polymer is a polyamic acid sodium salt.

5. The nIR fluorescent nanosensor as described in claim 4, wherein the polyamic acid sodium salt comprises one or more of a hydrophobic backbone, pendant carboxylate anions and pyridyl groups.

6. The nIR fluorescent nanosensor as described in claim 1, wherein the nanosensor is sensitive and specific to Fe(II) species.

7. The nIR fluorescent nanosensor as described claim 2, wherein the water-soluble polymer is poly(phenylene ethynylene).

8. The nIR fluorescent nanosensor as described in claim 7, wherein the nanosensor is sensitive to both Fe(II) and Fe(III) species.

9. The nIR fluorescent nanosensor as described in claim 8, wherein the nanosensor exhibits a strong turn-on response to Fe(II) and gives a quenching response to Fe(III).

10. The nIR fluorescent nanosensor as described in claim 1, wherein the water-soluble polymer is non-covalently absorbed to SWNT.

11. The nIR fluorescent nanosensor as described in claim 10, wherein the non-covalent adsorption provides selective interaction between the water-soluble polymer and iron ions.

12. The nIR fluorescent nanosensor as described in claim 1, wherein the nanosensor further comprises a compatible hydrogel matrix.

13. The nIR fluorescent nanosensor as described in claim 12, wherein the hydrogel matrix encapsulates the SWNT.

14. The nIR fluorescent nanosensor as described in claim 12 or 13, wherein the nanosensors are immobilised in the hydrogel matrix.

15. The nIR fluorescent nanosensor as described in claim 1, wherein the complexation comprises a complexation of SWNT with a water-soluble polyamic acid sodium salt and a complexation of SWNT with a water-soluble poly(phenylene ethynylene).

16. The nIR fluorescent nanosensor as described in claim 1, wherein the complexation was developed based on Corona Phase Molecular Recognition, and this sensor can be further chemically modified for detection of other analytes, including boron (B), zinc (Zn), manganese (Mn), iron (Fe), copper (Cu), molybdenum (Mo) and chlorine (Cl).

17. A system for detecting iron species in a sample, comprising:
a nIR fluorescent nanosensor as described in claim 1;
a light source; and
a nIR camera for capturing at least one image, spectrum or partial spectrum, of the sample and/or nIR fluorescent nanosensor after illumination by the light source.
